(19) United States
(12) Patent Application Publication
(10) Pub. No.: US 2018/0005463 A1
(43) Pub. Date: Jan. 4, 2018

(54) System, Device, and Method for Feature Generation, Selection, and Classification for Audio Detection of Anomalous Engine Operation

(71) Applicant: Massachusetts lnstitute of Technology, Cambridge, MA (US)

(72) Inventors: Joshua Eric Siegel, Bloomfield Hills, MI (US); lsaac M. Ehrenberg, Brookline, MA (US); Sumeet Kumar, Belmont, CA (US)

(21) Appl. No.: 15/639,408

(22) Filed: Jun. 30, 2017

Related U.S. Application Data
(60) Provisional application No. 62/356,640, filed on Jun. 30, 2016.

(51) Int. Cl. G07C 5/08; G10L 25/48; H04R 29/00

(52) U.S. Cl. CPC G07C 5/0808; H04R 29/00; G07C 5/0825; G10L 25/48; H04R 2499/13

(57) ABSTRACT

A device, system, and method for detecting faults in a vehicle includes a sensor proximate to the vehicle configured to produce sensor data that is stored and processed to generate a bulk feature set. Features are selected from the bulk feature set to produce a reduced feature set, and the reduced feature set is provided for a fault analysis of the vehicle, such that the reduced feature set does not substantially compromise accuracy of the fault analysis in comparison with a fault analysis based upon the bulk feature set.

### CROSS-REFERENCE TO RELATED APPLICATIONS

This application claims the benefit of U.S. Provisional Patent Application Ser. No. 62/356,640, filed Jun. 30, 2016, entitled “Method for Feature Generation, Selection, and Classification for Audio Detection of Anomalous Engine Operation,” which is incorporated by reference herein in its entirety.

### FIELD OF THE INVENTION

The present invention relates to motor vehicles, and more particularly, is related to using audio to diagnose vehicle conditions.

### BACKGROUND OF THE INVENTION

Vehicle maintenance has become an increasingly important part of vehicle ownership. Proactive or rapid-response maintenance may save significant cost over the life of a vehicle and reduce the likelihood of an unexpected breakdown. Anticipatory maintenance can further alleviate reliability concerns and increase the overall satisfaction of vehicle owners and operators through reduced fuel consumption, emissions, and improved comfort. Accordingly, the consumer-facing diagnostic market for vehicles has grown to include products intended to help vehicle owners maintain and supervise the operation of their vehicles without the assistance of a mechanic.

A primary maintenance requirement for many vehicles is the engine, which is responsible for efficient and reliable propulsion. Automotive internal combustion engines generally require only three elements to run: a supply of fuel, intake air, and ignition sparks. Delivery of one or more of these elements can fail, as is the case when an air filter or fuel injector clogs or when an ignition coil is damaged. One common engine fault results from a weak or non-existent spark, causing the fuel in a cylinder to fail to combust. With one or more cylinders failing to explode and generate motive force, fuel efficiency and power output drop, with the engine operation increasing in noise, vibration, and harshness. This fault, called a “misfire,” may result in engine wear and hesitation upon acceleration. A weak spark may be the result of neglected maintenance, such as fouled spark plugs, or component failure, such as an intermittently connected plug wire or an ignition coil pack stressed from powering improperly gapped spark plugs.

Beyond the cost of damage resulting from inaction, misfires have the potential to incur significant additional fuel costs resulting from inefficient or incomplete combustion. In modern vehicles, computer systems monitor combustion, misfires, and other emission-related functions through a system called “On Board Diagnostics” (OBD). While OBD systems are capable of detecting a misfire, they may be slow to react, rely on proprietary and non-standard algorithms, and necessitate the use of a specialized interface device to provide human-readable information. Though OBD tools are available, they may be unused by the average vehicle owner.

Engine misfires may be detected in a variety of ways. Under normal operating conditions, the engine crankshaft rotates through a fixed angular displacement between every cylinder firing attempt. A misfire detectably alters the precession of the crankshaft which is sensed by a crankshaft position sensor. Measuring a series of unexpected angular measurements within a time window prompts the illumination of a check engine light indicating that the engine is operating outside of specifications and malfunctioning. The use of an OBD scan tool may reveal which cylinder or cylinders are misfiring, but this information is of uncertain provenance and dubious value due to the use of proprietary classification schemes. Some direct-sensing alternatives to crankshaft position-based detection include sampling of the instantaneous exhaust gas pressure, measuring ionization current in the combustion chamber, or installing other sensors within or outside the combustion chamber.

Other diagnostics have demonstrated the capacity to identify misfires through audio signal processing. Aside from less obviously discernible symptoms like increased fuel consumption or visual indications like an oily or white residue on the tip of the spark plug, misfires have a characteristic audible pop and cause the engine to vibrate as though it is unbalanced or otherwise missing a beat. Auto mechanics have long employed a form of auditory diagnosis, listening to engines and easily determining the presence of a misfire.

Existing sensors used for limited purposes may collect data that may be used to provide insight into existing or potential vehicle faults. However, even if this data was collected for fault analysis, the volume of data collected may make such analysis impractical for on-board processors, and similarly, may consume too much bandwidth to transmit to external processors. Therefore, there is a need in the industry to address one or more of the abovementioned shortcomings.

### SUMMARY OF THE INVENTION

Embodiments of the present invention provide a system, device, and method for feature generation, selection, and classification for audio detection of anomalous engine operation. Briefly described, the present invention is directed to a device, system, and method for detecting faults in a vehicle. A sensor proximate to the vehicle is configured to produce sensor data that is stored and processed to generate a bulk feature set. Features are selected from the bulk feature set to produce a reduced feature set, and the reduced feature set is provided for a fault analysis of the vehicle, such that the reduced feature set does not substantially compromise accuracy of the fault analysis in comparison with a fault analysis based upon the bulk feature set.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram showing a first exemplary embodiment of a system for automotive fault analysis.

FIG. 2 shows two graphs comparing a segment of a normal audio sample with a misfiring audio sample.

FIG. 3 is a graph comparing the spectral density of a normal audio sample with a misfiring audio sample.

FIG. 4 is a graph comparing of feature scores calculated by the Fisher methodology and the Relief Score methodology.

FIG. 5 shows three graphs illustrating weights of FFT features, DWT features and MFCC features scored by the three scoring methods, Fisher Score, Relief Score and Average Score, where the score percentile cutoff p=0.9 and the selection cutoff threshold is indicated as the dotted line.

FIG. 6 is a graph comparing a 10-fold misclassification rate (MCR) and the feature set size with the variation in the percentile cutoff p.

FIG. 7 is a flowchart of an exemplary method for collecting and reducing data used to detect vehicle faults.

FIG. 8 is a schematic diagram illustrating an example of a system for executing functionality of the present invention.

FIG. 9 is a schematic diagram showing a second exemplary embodiment of a device for automotive fault analysis.

FIG. 10 is a flowchart of an exemplary method for determining a feature selection threshold for detecting engine anomalies with audio.

### DETAILED DESCRIPTION

The following definitions are useful for interpreting terms applied to features of the embodiments disclosed herein, and are meant only to define elements within the disclosure.

As used within this disclosure, “local” refers to devices located physically proximate to the vehicle being analyzed (in, near, or on the vehicle), for example a device that is proximate to the vehicle may be integral to the vehicle or a device being transported by the vehicle (such as a smart phone), for example but not limited, within a passenger or cargo portion of the vehicle, or within an engine compartment of the vehicle, while “remote” refers to devices and/or resources that are external to the vehicle, for example, a cloud based storage device or computer. A device proximate to the vehicle may be external to the vehicle, for example, a microphone located outside a stationary, idling vehicle, such that the microphone is able to detect pick up sound emitted by the engine.

To provide fault detection to improve vehicle condition monitoring, the exemplary embodiments described herein are configured to detect automotive faults passively, reliably, and without specialized equipment, applying sensing from devices such as mobile phones and allowing location and orientation-independent analysis. The embodiments may capture time domain signals and then transform these signals for analysis, for example, the sound emanating from an abnormally firing engine captured from a distance by a microphone, for analysis in both the time and frequency domains for patterns indicative of cylinder misfires.

The exemplary embodiments avoid a dedicated code-reading device and enable pervasive sensing to allow drivers to monitor the health of their vehicles with increasing frequency without additional cost. Through improved early detection, the source of a misfire may be addressed easily and inexpensively, for example via the replacement of a spark plug, wire, or ignition coil, before the failure takes a more costly toll on other components like the catalytic converter due to long-term rich fuel trim. The embodiments leverage the proliferation in mobile devices concurrent with recent advances in sensing and computation. Some embodiments use mobile phones as automotive triage devices for non-invasively detecting vehicle conditions, which may encourage drivers to take an active role in vehicle maintenance through improved ease-of-use and widespread adoptability relative to current diagnostic offerings. Passive sensing allows a shift from a paradigm of reactive repair to one of proactive maintenance.

Reference will now be made in detail to embodiments of the present invention, examples of which are illustrated in the accompanying drawings. Wherever possible, the same reference numbers are used in the drawings and the description to refer to the same or like parts.

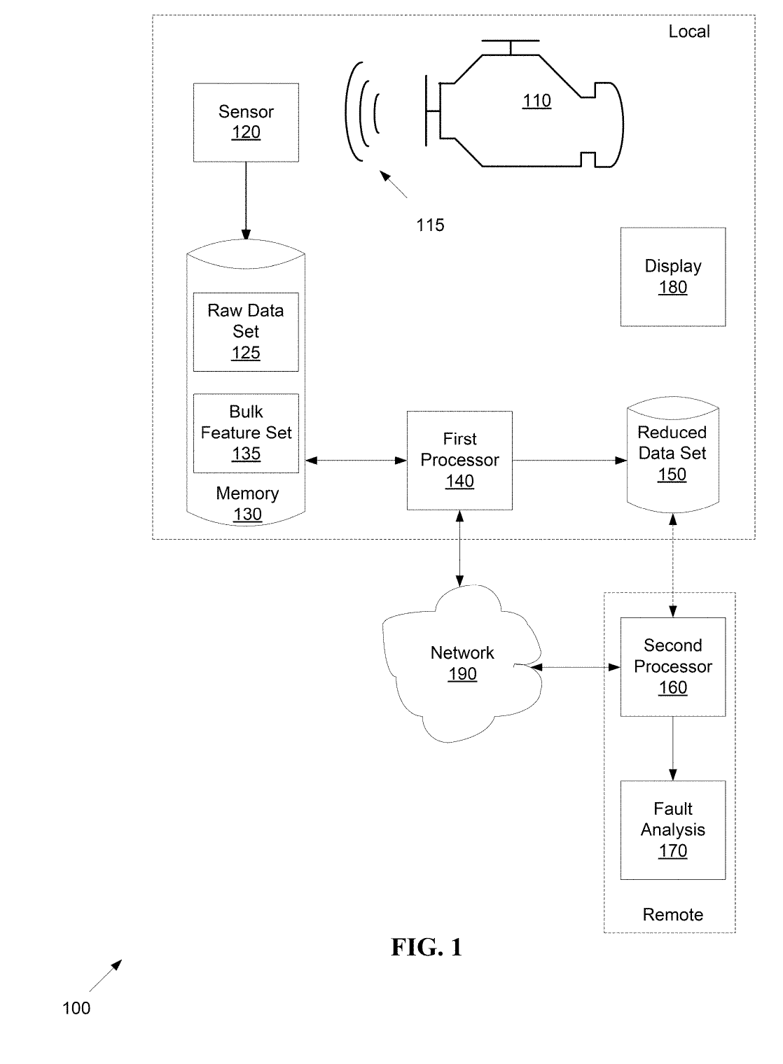

Under a first embodiment of a system 100 for detecting engine faults, a sensor 120 proximate to the vehicle, for example a smart phone microphone, senses a signal 115, for example audio emanating from an engine 110, and produces sensor data collected as a raw data set 125, which is stored by a memory 130. The raw data set 125 may be digital, for example a WAV audio file, or may be analog data that is converted to digital via an analog-to-digital converter (ADC, not shown). Other types of sensors 120 that may be used to collect the raw data set 125 include, for example, a smart phone accelerometer, a gyroscope, position, location, and orientation sensors, luminosity sensors, or a sensor built-in to the vehicle. While FIG. 1 depicts the signal 115 emanating from an engine 110, the source of the signal 115 may be from other parts of the vehicle, for example, the wheels, transmission, suspension, or electrical system, among other parts of the vehicle.

The collecting of the raw data set 125 does not rely on fixed position or orientation of the vehicle or sensor 120, and the background environment need not be controlled or suppressed, so the raw data set 125 may include ambient sources such as wind and other vehicles to add noise to the raw data set 125. Therefore, the signal data collection may be non-invasive and uncontrolled. The sampling window for the signal may be, for example, between one second and two minutes. For example, a mobile phone may record the engine sound as an uncompressed stereo WAV file at 48000 Hz.

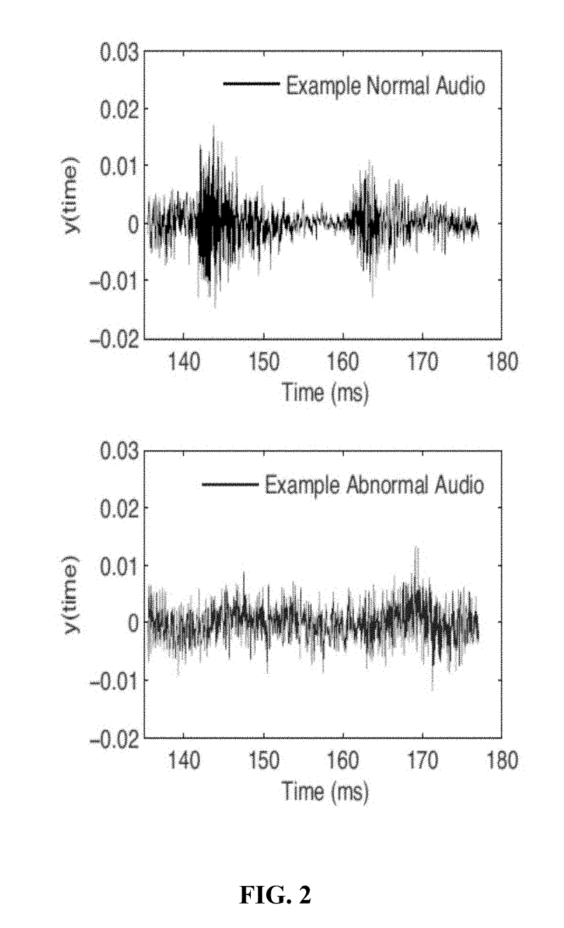

A first processor 140 may access the raw data set 125 from the memory 130 to assign labels to the raw data set 125, for example, indicating the condition of the engine 110 while the raw data set 125 was collected. The signal data may be pre-processed, filtered for example, to reduce noise and/or collection artifacts. The first processor 140 may also perform other pre-processing operations, such as converting a stereo data to mono. FIG. 2 shows a segment of a normal engine audio signal for comparison with a misfiring engine audio sample.

It should be noted that in alternative embodiments a user of the system may provide labels and/or validate labels provided by the first processor 140. For example, a data collection application may be used by drivers or mechanics who may record samples with knowledge of the context beforehand, therefore capturing the data set with a known, human assigned, label rather than a machine (processor) assigned label. Accordingly, alternative embodiments may incorporate supervised and/or unsupervised learning.

The first processor 140 converts the raw data set 125 into a bulk feature set 135 or bulk feature vector to allow for classification without the need for targeted, hypothesis-driven feature creation. Under the first embodiment, three classes of feature construction may be employed and concatenated to form a long feature vector. The three classes may include binned Fourier Transform coefficients, Wavelet Transform coefficients, and Mel Frequency Cepstral coefficients, among others. In alternative embodiments one, two, four, or more classes of feature construction may be employed.

Though dense feature generation is typically an intensive process, it advantageously removes any preconceived bias on what features have good discriminative power and it is preferable to allow machine learning techniques to drive the solution towards a reduced size feature set. A reasonable feature set size, for example, 10-1000 features or more depending upon the application, allows rapid computation by the second processor 160, for example, the programmable Digital Signal Processors (DSPs) on mobile devices. Use of such processors has been shown to minimize a classification algorithm's impact on battery life significantly, even allowing cloud-free operation, or alternatively distributed processing between local DSP computation and data transmission to the cloud in order to minimize overall power consumption and enable pervasive sensing with minimal distraction to drivers. Further, operating in this manner allows the phone of the driver to conduct diagnostics in the background during normal usage.

Discrete samples in the raw data set 125 may be first normalized by the first processor 140 based on power and detrended to remove bias and linear drift. A transform operation, such as a Fourier Transform (FT), for example, a Fast Fourier Transform (FFT), may then be applied by the first processor 140 to convert the detrended time-domain signals into the frequency domain. Frequencies below 10 kHz may be divided into bins 10 Hz wide. Higher frequencies may be discarded as they may not provide additional differentiation because on average they represent less than twenty five percent of the total energy and typically represented harmonics of lower frequencies. The average FT magnitude in each bin may provide one feature. This process may result in the creation of a feature vector, for example of size 1000. The size of the bins may be increased or decreased depending upon the desired granularity.

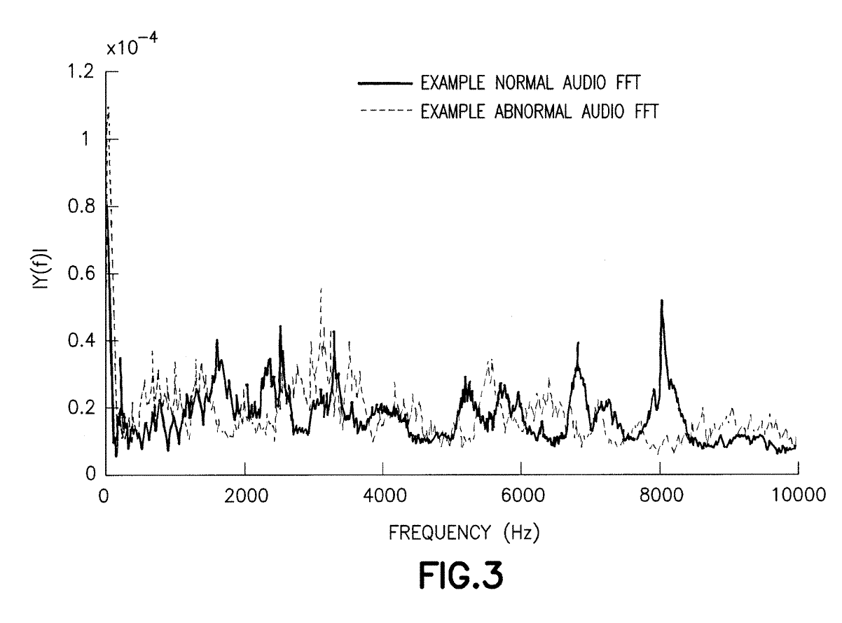

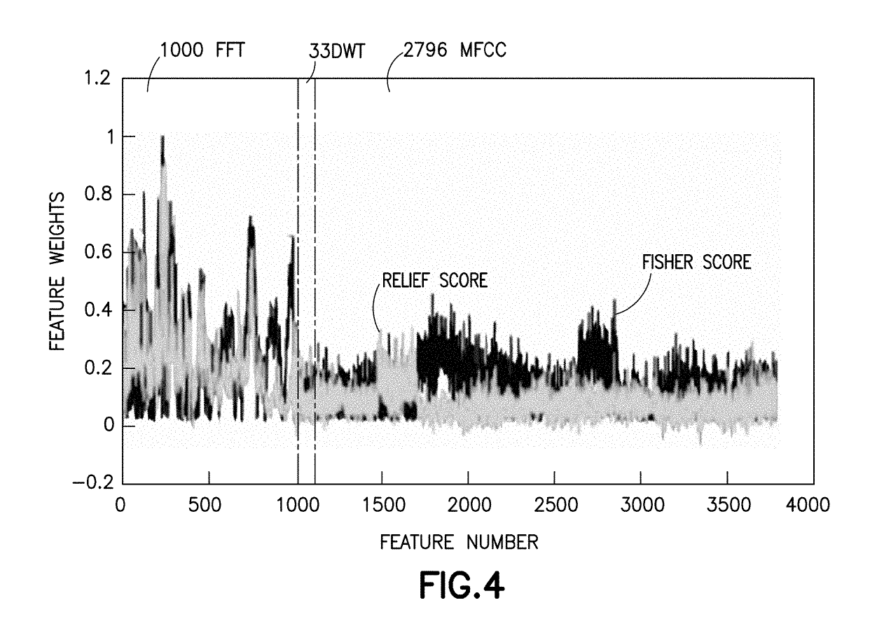

FIG. 3 shows an example comparison of the magnitude of the FT of a normal engine audio signal with a misfiring engine audio sample. As shown in FIG. 4, several frequencies (in this particular example segment, around 2 kHz and 8 kHz) have a distinct pattern in the normal vs. abnormal cases. These frequencies that are statistically more powerful classifiers may be identified and used to classify a normal engine from a misfiring engine. However, these features alone may not provide robust classification

In addition to the binned FT, a wavelet decomposition of the raw data set 125 by the first processor 140 may be combined, for example, at level 10 on the power normalized, detrended discrete signal using Daubechies 4 wavelets. At each level of signal decomposition, mean, standard deviation and skewness may be computed resulting in, for example but not limited to, a 33-dimensional feature vector. For example, a more fine grained decomposition will result in more dimensions.

A Mel Frequency Cepstral Coefficient (MFCC) may be performed on the raw data set 125 by the first processor 140, creating a spectral signature of short-term frames of the original signal in a manner similar to that applied to speech recognition. For example using a frame size of 1024 samples, with each frame incrementally shifted by 512 samples leads to a total number of 233 frames. For each frame 12 MFCC coefficients may be extracted to form a feature vector of size 2796. Feature extraction may be performed using known methods, for example, by use of the GNU-licensed Voicebox toolbox for MATLAB to conduct MFCC feature extraction.

Concatenating the three sets of feature vectors from the FT, DWT, and MFCC by the first processor 140 results in a multi-dimensional feature representation of the audio signal and a data matrix. The data set may be randomly divided into two sets, for example but not limited to, a 50% training set and a 50% test set. Typically, samples of each state may be drawn from different recording events. Alternatively, segments of the same file may be used in both training and testing. In such cases, the movement of the sensor 120 may minimize the likelihood that samples are taken from similar locations and orientations, reducing classification dependence on sample timing. After splitting the segments, the first processor 140 applies appropriate feature reduction and classification techniques to produce a reduced feature set 150, as described further below.

Under the first embodiment, feature selection techniques may be employed by the first processor 140 to reduce the higher-dimensional feature vector of the bulk feature set 135 to simplify computation, reduce redundancy and training time, and minimize overfitting. Two exemplary filter-based methods for feature ranking are Fisher Score (FS) and Relief Score (RS). The use of feature ranking methods enables low-power and resource-constrained devices to perform this type of classification on the full bulk feature set 135 by eliminating the need to generate, transmit, store, or classify upon certain features.

The Fisher score of a feature for binary classification may be calculated using:

$$\begin{matrix}FS ( {f}_{i} ) = \frac{{{n}_{1} ( {μ}_{1}^{i} - {μ}^{i} )}^{2} + {{n}_{2} ( {μ}_{2}^{i} - {μ}^{i} )}^{2}}{{{n}_{1} ( {σ}_{1}^{i} )}^{2} + {{n}_{2} ( {σ}_{2}^{i} )}^{2}} \\ = \frac{1}{n} \frac{{( {μ}_{1}^{i} - {μ}_{2}^{i} )}^{2}}{\frac{{( {σ}_{1}^{i} )}^{2}}{{n}_{1}} + \frac{{( {σ}_{2}^{i} )}^{2}}{{n}_{2}}} ,\end{matrix} \qquad ( Eq . 1 )$$

where ηⱼ is the number of samples belonging to class j, η=η₁+η₂, μⁱ is the mean of the feature fⁱ, μⁱⱼ and σⁱⱼ are the mean and the standard deviation of fᵢ in class j. A larger score value corresponds to a variable having higher discriminating power.

The Relief score of a feature is computed by first randomly sampling m instances from the data and then using:

$$RS ( {f}_{i} ) = \frac{1}{2} {\sum }_{k = 1}^{m} d ( {f}_{k}^{i} - {f}_{NM ( {x}_{k} )}^{i} ) - d ( {f}_{k}^{i} - {f}_{NH ( {x}_{k} )}^{i} ) , \qquad ( Eq . 2 )$$

where fⁱₖ denotes the value of the feature fᵢ on the sample xₖ, fⁱ_{N H(xk)} and fⁱ_{N M(xk)} denote the values of the nearest points to xₖ on the feature f₁ with the same and different class label respectively, and d(•) is a distance measure chosen to be the l₂ norm, where d(•) is a mathematical notation indicating that d is a distance measure applied to a variable, for example x, in this case chosen to be sqrt(|x|²) or the l₂ norm. Here again, a larger score indicates a higher discriminating power of the variable.

FIG. 4 shows the normalized score (scaled to ε [0, 1]) computed by the two methods noted above for each of the generated features. Though there may be a significant correlation between the weights of FS and RS (for example, a linear correlation coefficient of 0:49), combining the information from the two scoring methods may reduce the likelihood of overfitting. To achieve this, a simple average may be taken of the Fischer score and the Relief score to produce an average score (AS), calculated by:

$$AS ( {f}_{i} ) = \frac{1}{2} ( \frac{FS ( {f}_{i} )}{max ( FS ( {f}_{i} ) ) - min ( FS ( {f}_{i} ) )} + \frac{RS ( {f}_{i} )}{max ( RS ( {f}_{i} ) ) - min ( RS ( {f}_{i} ) )} ) . \qquad ( Eq . 3 )$$

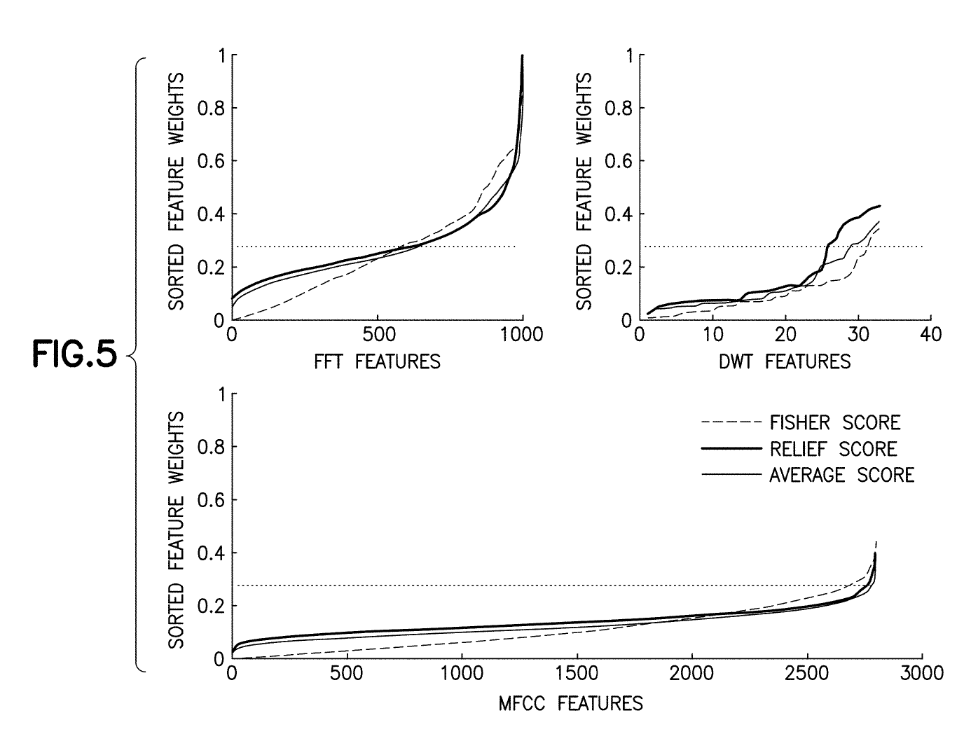

After the features are scored, a systematic feature reduction study may be performed in order to identify a suitable subset of features. These feature subsets may parametrized by a variable p (percentile cutoff), with all features whose scores were in the top 1−p percentile for discrimination included in the subset. An example demonstrating how feature selection varies with the FS, RS, and AS method is shown in FIG. 5.

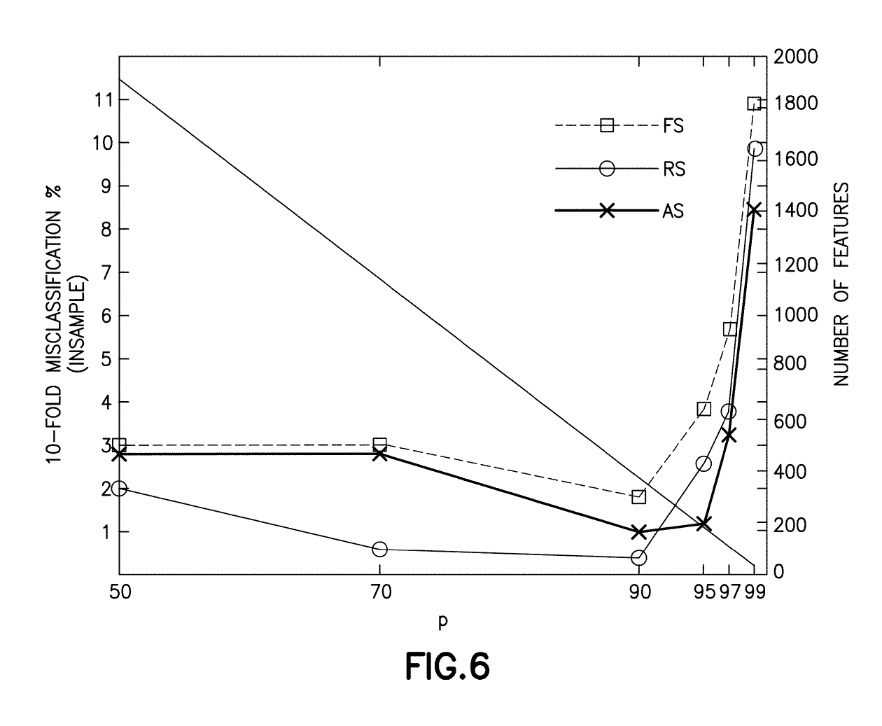

FIG. 6 shows the variation in the 10-fold Misclassification Error Rate (MCR) on an exemplary training set using a linear Support Vector Machine (SVM), as well as the feature set size (#F) for different scoring schemes and the percentile cutoff p. A grid search may be performed to find the optimal box constraint hyper-parameter (C) for each of the feature subsets in the figure. A minimum MCR, for example, at p=90 for each of the three feature scoring methods may be identified, for example by inspection. Selection of a lower percentile cutoff p generally results in a higher number of less informative features in the subset, which may lead to overfitting and poorer cross-validation performance. Use of a higher percentile cutoff p may remove important features from the subset leading to a weaker model with decreased accuracy. It has been observed that with the AS feature ranking the MCR increases less sharply after percentile cutoff p=90 when compared to FS or RS, which may be attributable to variance reduction by model averaging. Therefore AS with a percentile cutoff percentile cutoff p=90 may be selected as the optimal feature subset selection criterion.

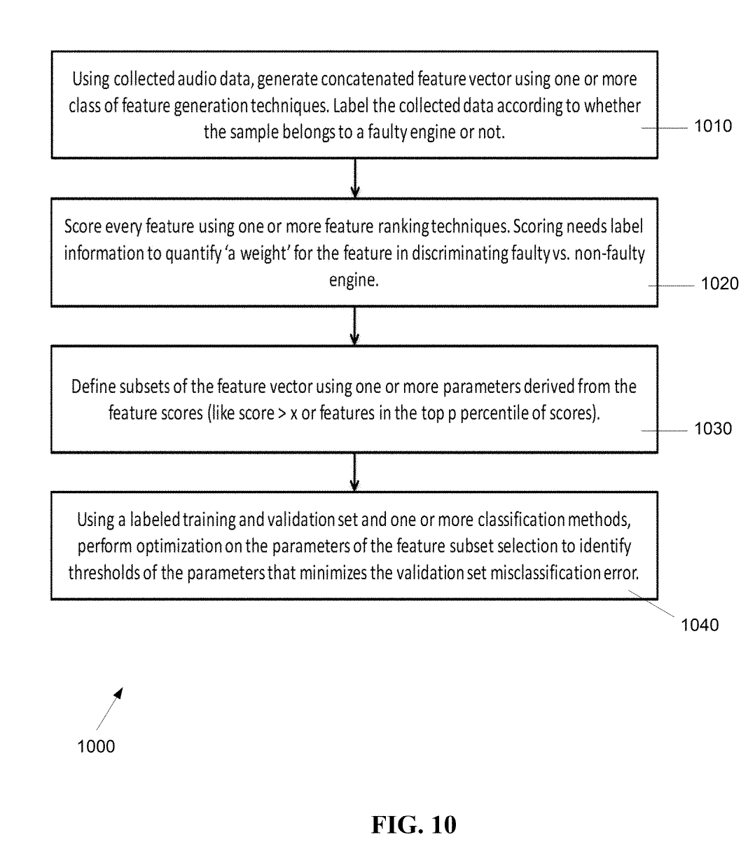

FIG. 10 is a flowchart 1000 of an exemplary method for determining a feature selection threshold for detecting engine anomalies with audio. Collected audio data is used to generate concatenated feature vector using one or more class of feature generation techniques. The collected data may be labeled according to whether the sample belongs to a faulty engine or not, as shown by block 1010. Every feature may be scored using one or more feature ranking techniques. For example, the score may use label information to quantify a weight for the feature in discriminating faulty vs. non-faulty engine, as shown by block 1020.

Subsets of the feature vector may be defined using one or more parameters derived from the feature scores, for example, a score>x or features in the top p percentile of scores, as shown by block 1030. Using a labeled training and validation set and one or more classification methods, optimization may be performed on the parameters of the feature subset selection to identify thresholds of the parameters that minimizes the validation set misclassification error, as shown by block 1040.

While use of multiple features sets may yield desirable results, in some cases use of a single feature set may be more effective. For example, applying the binned FT features alone may result in a relatively low misclassification rate, for example under 1%, while the DWT and MFCC based features may provide a significantly higher misclassification rate, for example on the order of 30% or more. Due to this disparity, concatenating the FT, DWT, and MFCC features may result in a misclassification which is higher than FT alone.

The FT features may have a higher discriminating power when compared to the other two classes of features, so simply combining the features from all three may not provide more discrimination than using the FT features. The ability to perform feature ranking and selecting the optimal subset generally improves the ratio of the discriminating power to the feature set size (i.e. (1−MCR)/#F) and therefore may help determine a small feature set with high discriminative power.

Returning to FIG. 1, using the chosen reduced feature set (AS feature weighting with the percentile cutoff p=90 and 1−p=the top 10th percentile of features selected), several classification approaches may be applied by the first processor 140 and/or a second processor 160. Hyperparameters of the classifications may optimized by conducting a grid search to minimize 10-fold cross-validation on the training data. Exemplary approaches include k-Nearest Neighbor, Adaboost and SVM with linear, quadratic and RBF kernels, among others. In some instances of SVM with a quadratic kernel, all choices of the hyper parameter box-constraint cost (C) may lead to the same 10-fold misclassification error, while for the RBF kernel the error may drop sharply, for example, from 38% to 0% around the optimal grid points (for finding C and γ). Therefore in some scenarios the quadratic and RBF SVM classifiers may not provide a robust set of optimal hyperparameters. The resulting reduced feature set 150 may be locally stored, or remotely stored, for example in cloud storage.

Calculating the percentile cutoff p is typically processor intensive, and may therefore be performed in advance of the fault data collection, reduction, and analysis. For example, the percentile cutoff p may be calculated remotely, for example, in the cloud, or predetermined “offline” for different types of vehicle engines (for example, single cylinder engines, rotary engines, in-line engines of 2-12 cylinders or V configured engines of 2, 4, 6, 8, 12 or more cylinders, among others), such that the percentile cutoff p used for the feature reduction calculation may be selected according to a selection of the type of engine in the vehicle being monitored by the sensor 120, for example, as a parameter in an application performing the feature reduction calculation. Under the first embodiment, the first processor 140, for example, a local processor, may provide the vehicle engine type as a parameter to the second processor 160, for example, a remote processor, and the second processor 160 may calculate or look up the percentile cutoff p and provide the percentile cutoff p to the first processor 140 for use in the feature reduction calculation. For example, the first embodiment may be implemented as an application, or “app” executed by the first processor 140 on a mobile computing device that is in communication with a remote second processor 160 via a communication network 190, such as a cellular phone network.

The second processor 160 may be a remote processor, for example a cloud based computer, that either receives the reduced feature set 150 from the first processor 140 or has access to the reduced feature set 150, for example via the network 190, to perform an analysis of the reduced feature set 150 to detect a vehicle fault, and producing a fault analysis 170 indicating an existing or potential vehicle fault, which may be communicated to the driver of the vehicle for example, via a text message, or communicated to the vehicle OBD system for display to the driver, for example, via a vehicle dashboard display 180.

The in general, the fault analysis 170 may be obtained by the second processor 160 performing bulk training techniques, for example by executing a linear Support Vector Machine (SVM), or a classical decision tree, via MATLAB on the reduced feature set 150. For example, linear SVMs are supervised learning models with associated learning algorithms that analyze data used for classification and regression analysis. After partitioning a set of training examples, and marking as belonging to one or the other of two categories, an SVM training algorithm builds an SVM model that assigns new examples to one category or the other. The SVM model is a representation of the examples as points in space, mapped so that the examples of the separate categories are divided by a clear gap that is as wide as possible. New examples are then mapped into that same space and predicted to belong to a category based on which side of the gap they fall.

While the fault analysis 170 may be derived based on either the bulk feature set 135 or the reduced feature set 150, using the reduced feature set 150 does not substantially compromise accuracy of the fault analysis 170 in comparison with an analysis based upon the bulk feature set 135. As used herein, “substantially” indicates that the accuracy of the fault analysis using the reduced feature set 150 is within +/−2.5% of an analysis based upon the bulk feature set 135, and the fault analysis based upon the reduced feature set 150 may be more accurate than the analysis based upon the bulk feature set 135, as the fault analysis based upon the reduced feature set 150 may increase accuracy by reducing overfitting.

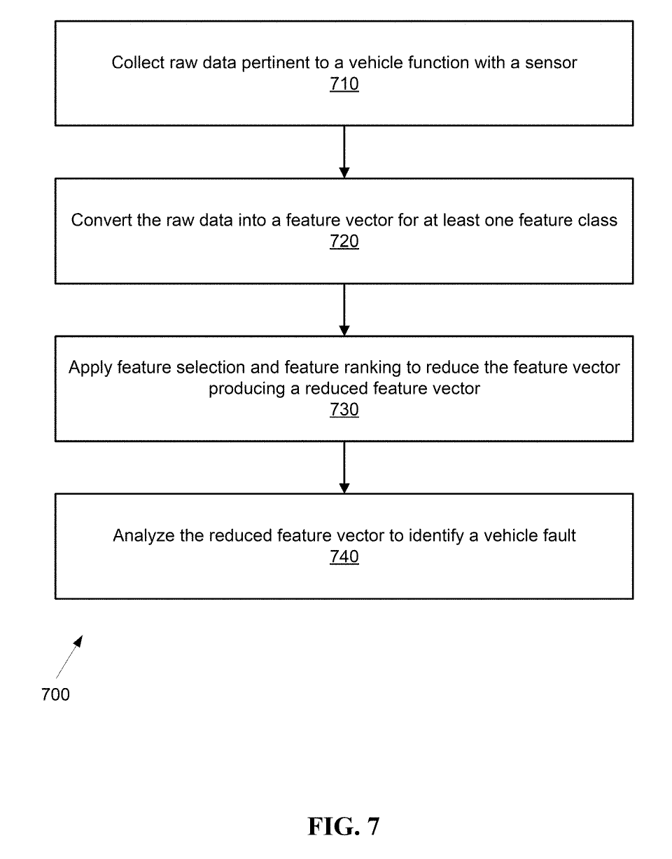

FIG. 7 is a flowchart 700 of an exemplary method for collecting and reducing data used to detect vehicle faults. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention. The following description is made with reference to FIG. 1.

A raw data set 125 pertinent to a vehicle function is collected by a local sensor 120 as shown by block 710. For example, the local sensor 120 may be a smart phone microphone, a smart phone accelerometer, a gyroscope, or other sensor able to receive, for example, but not limited to an auditory signal, electrical signal, orientation, location, or vibration from the vehicle. The raw data set 125 may be stored in a memory 130. The raw data set 125 is converted by a local processor 140, for example, a processor in a smart phone, into a bulk feature set 135 or bulk feature vector for at least one feature class as shown by block 720. The bulk feature set 135 may be stored in the memory 130. Feature selection and feature ranking is applied by the first processor 140 to reduce the bulk feature set 135 into a reduced feature set 150 or reduced feature vector as shown by block 730. The reduced feature set 150 may be stored in a remote memory, for example, a cloud based memory accessed via a cellular telephone network 190 by a smart phone. The reduced feature vector (reduced feature set 150) may be analyzed, for example, by the second processor 160, to produce a fault analysis 170 identifying an existing and/or potential vehicle fault as shown by block 740. The fault analysis 170 may be displayed via a vehicle display 180.

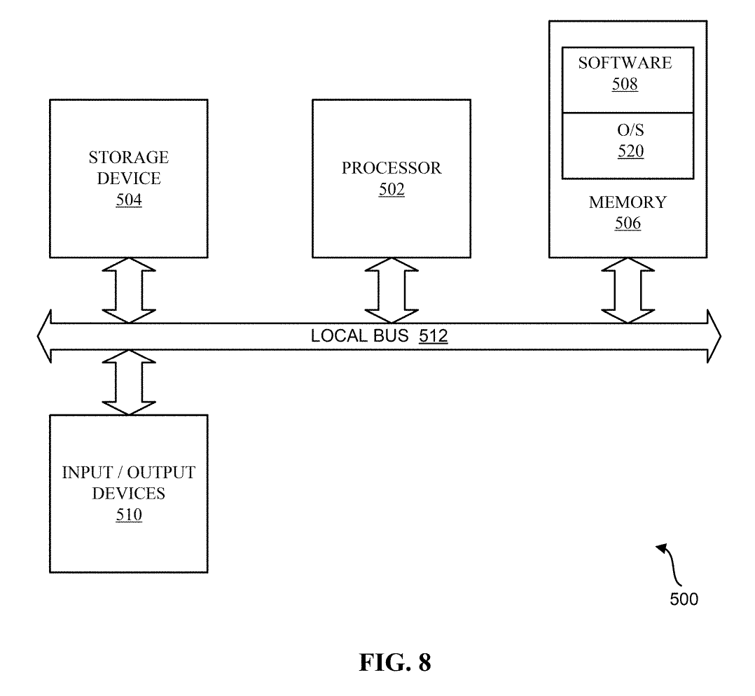

It should be noted that while the above description divides the data processing in to two steps by a first (local) processor 140 and a second (remote) processor 160, in alternative embodiments, such as the second embodiment described below, the processing may be entirely performed by one or more local processors, or be partitioned among one or more local processors and/or one or more remote processors. An example of one such processor system 500 (a computer) is shown in the schematic diagram of FIG. 8. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

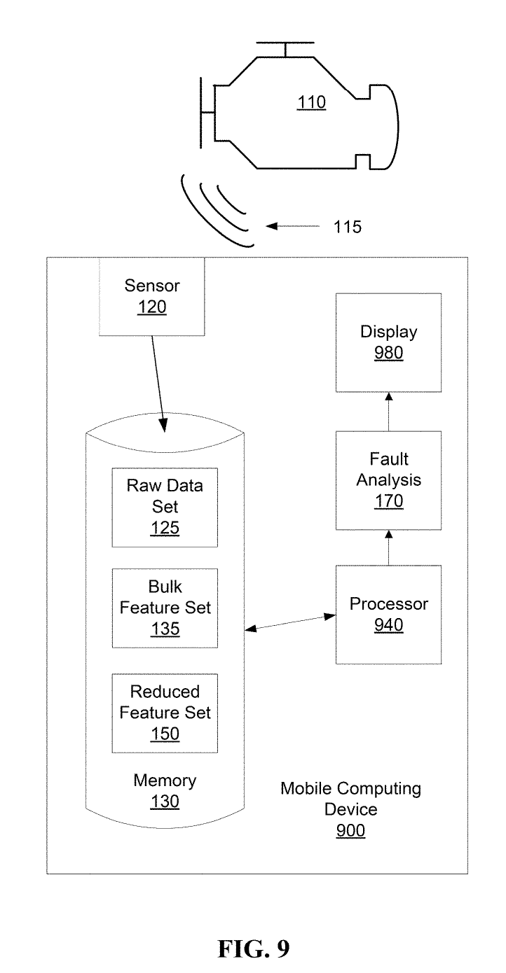

FIG. 9 is a schematic diagram of a second embodiment of a device 900 (for example, a mobile computing device 900 such as a smart phone) for detecting engine faults. A sensor 120, for example a smart phone microphone proximate to a vehicle having an engine 110, senses a signal 115, for example audio, emanating from the engine 110, and produces a raw data set 125, for example, of audio samples, which is stored in a memory 130. The raw data set 125 may be digital, for example a WAV audio file, or may be analog data that is converted to digital via an analog-to-digital converter (ADC, not shown). As described above regarding the first embodiment, other types of sensors 120 may be used to collect the raw data set 125, including but not limited to, for example, a smart phone accelerometer, a gyroscope, or a sensor built-in to the vehicle. While FIG. 9 depicts the signal 115 emanating from an engine 110, the source of the signal 115 may be from other parts of the vehicle, for example, wheels, transmission, electrical system, among others.

A processor 940, for example, a general purpose processor or a digital signal processor resident in the mobile computing device 900, processes the raw data set 125 to produce a bulk feature set 135, also stored in the memory 130, which the processor 940 then uses to produce a reduced feature set 150 as described above regarding the first embodiment as being performed by the first processor 140 (FIG. 1). The reduced feature set 150 may be stored in the memory 130. The processor 940 may then produce a fault analysis 170 based upon the reduced feature set 150 in the memory 130.

The results of the fault analysis 170 may be displayed, for example, by a display 980 of the mobile computing device 900, for example, a smart phone display screen. The second embodiment may be implemented as an application, or “app” running on the mobile computing device 900.

The feature ranking techniques used in the embodiments described above facilitate the discarding of features with minimal loss in accuracy. These unused features need not be computed, enabling more efficient implementations of feature generation processing suited to the limited resources found on mobile devices. Additionally, improving the offline efficiency of these algorithms enables improved on-line approach, for example by minimizing bandwidth used for unnecessary data transmission and decreasing reference database size. Therefore, the feature ranking technique improves the functionality of a mobile device by enabling such devices to perform fault analysis due to a data set that has been reduced to remove unneeded information from a collected data set that is not needed to diagnose an automotive fault.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for fault detection and providing a fault analysis for a vehicle comprising:
a sensor proximate to the vehicle configured to produce sensor data;
a first processor and a memory configured to store non-transitory instructions that, when executed by the first processor, performs the steps of:
receiving the sensor data;
performing a data transformation to generate a bulk feature set from the sensor data; and
selecting a subset of features from the bulk feature set to produce a reduced feature set; and
a second processor and a memory configured to store non-transitory instructions that, when executed by the second processor, performs the step of receiving the reduced feature set for the fault analysis for the vehicle,
wherein the reduced data set does not substantially compromise accuracy of the fault analysis accuracy in comparison with a fault analysis based upon the bulk feature set.

2. The system of claim 1, wherein the second processor further performs the steps of:
analyzing the reduced feature set; and
producing the fault analysis.

3. The system of claim 2, further comprising a display configured to display the fault analysis.

4. The system of claim 1, wherein the bulk feature set comprises a bulk feature vector for at least one feature class, the reduced feature set comprises a reduced feature vector for the at least one feature class, and the feature selection comprises ranking a feature of the at least one feature class.

5. The system of claim 4, further comprising the step of:
assigning a score to a plurality of features of the bulk feature set,
wherein selecting a subset of features from the bulk feature set to produce a reduced feature set further comprises selecting features having an assigned score above a threshold.

6. The system of claim 5, wherein the score comprises a Fisher score and/or a relief score and/or an averaging of the Fisher score and the relief score.

7. The system of claim 5, further comprising the steps of:
calculating the threshold.

8. The system of claim 1, wherein the sensor comprises a microphone and the sensor data comprises audio samples.

9. The system of claim 4, wherein the at least one feature class includes one or more of the group consisting of Binned Fourier Transform (FT) coefficients, Discrete Wavelet Transform (DWT) coefficients, and Mel Frequency Cepstral Coefficients (MFCC).

10. The system of claim 1, further comprising a communication network in communication with the first processor and memory and the second processor and memory, wherein the first processor and memory are located proximate to the vehicle, the second processor and memory are located remotely from the vehicle, and the second processor and memory receive the reduced data set or access the reduced data set via the communication network.

11. A computer based method for collecting and reducing data used to detect vehicle faults for processing, comprising the steps of:
collecting raw data pertinent to a vehicle function with a sensor;
converting the raw data into a bulk feature vector for at least one feature class;
applying feature selection to reduce the bulk feature vector producing a reduced feature vector; and
providing the reduced feature vector for an analysis to identify a vehicle fault,
wherein the feature selection comprises feature ranking.

12. The method of claim 11 further comprising the step of pre-processing the raw data to reduce noise.

13. The method of claim 11, wherein the feature ranking further comprises the steps of:
assigning a score to a plurality of features of the bulk feature vector; and
selecting a subset of features from the bulk feature vector having a predetermined score above a threshold.

14. The method of claim 13, wherein the score comprises a Fisher score and/or a Relief score.

15. The method of claim 13, further comprising the step of calculating the threshold.

16. The method of claim 11, wherein the at least one feature class includes one or more of the group consisting of Binned Fourier Transform (FT) coefficients, Discrete Wavelet Transform (DWT) coefficients, and Mel Frequency Cepstral Coefficients (MFCC).

17. The method of claim 11, wherein the local sensor comprises a microphone and the raw data comprises audio samples.

18. A device for detecting faults in a vehicle comprising:
a sensor proximate to the vehicle configured to produce sensor data;
a processor and a memory configured to store non-transitory instructions that, when executed by the processor, performs the steps of:
receiving the sensor data;
generating a bulk feature set from the sensor data; and
selecting features from the bulk feature set to produce a reduced feature set; and
providing the reduced feature set for a fault analysis for the vehicle,
wherein the reduced feature set does not substantially compromise accuracy of the fault analysis in comparison with a fault analysis based upon the bulk feature set.

19. The device of claim 18, wherein the sensor, processor, and memory are disposed within a portable computing device.

20. A system for fault detection and providing a fault analysis for a vehicle comprising:
a sensor proximate to the vehicle configured to produce sensor data;
a first processor and a memory configured to store non-transitory instructions that, when executed by the first processor, performs the step of receiving the sensor data from the sensor; and
a second processor and a memory configured to store non-transitory instructions that, when executed by the second processor, performs the step of:
receiving the sensor data from the first processor;
performing a data transformation to generate a bulk feature set from the sensor data; and
selecting a subset of features from the bulk feature set to produce a reduced feature set;
wherein the reduced data set does not substantially compromise accuracy of the fault analysis accuracy in comparison with a fault analysis based upon the bulk feature set.
